(19) United States
(12) Patent Application Publication
(10) Pub. No.: US 2004/0265099 A1
(43) Pub. Date: Dec. 30, 2004

(54) Conveyer system

(76) Inventors: Yu-Yen Chang, Taipei (TW); Hung-Wei Chen, Tainan City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/788,102

(22) Filed: Feb. 26, 2004

(30) Foreign Application Priority Data
Jun. 23, 2003 (TW) 92116936

(51) Int. Cl. B65G 1/00

(52) U.S. Cl. 414/331.13

(57) ABSTRACT

A conveyer system. The conveyer system includes a stocker and a conveyor. The stocker has a first position and a second position. The conveyor, with an Input/Output port, enters the stocker, wherein the Input/Output port is disposed between the first position and the second position.

### BACKGROUND OF THE INVENTION

1. Field of the Invention

The present invention relates to a conveyer system, and in particular to a conveyor entering a stocker to save space out of the stocker and tact time.

2. Description of the Related Art

In manufacture technology for liquid crystal displays, wire cassettes and conveyors move and carry large substrates. FIG. 1 shows a conventional conveyer system 100 for material. An Input/Output port 121 of a conveyor 120 is connected to an opening in the side of a stocker 110. Material G in a cassette C in a preparation position 111 is removed from the stocker 110 by the conveyor 120.

To comply with short tact time of manufacturing equipment, the conveyer system 100 continuously provides material. When supply is exhausted, however, cassette C is removed from preparation position 111, and another stocked cassette is reloaded in the preparation position 111. During cassette exchange, conveyor activity is interrupted.

FIG. 2 shows a second conventional conveyer system. To prevent conveyor activity interruption as described, the second conveyer system 200 further includes a buffer zone 230 disposed between a conveyor 220 and a stocker 210. The buffer zone 230 comprises a first position 211 and a second position 212, with a cassette C1 in the first position, and a cassette C2 in the second position 212. Material stored in the cassette is delivered to an Input/Output port 221 and transported by the conveyor 220. When empty, cassette C1 is relocated to an unloading position 213 in the stocker 210. The cassette C2 moves to fill the vacant first position 211 such that the duration of the conveyor interruption is shortened. Simultaneously, a cassette C3, originally in a third position 214, in the stocker 210, moves to fill the vacant second position 212, and another stocked cassette moves to the third position 214. The empty cassette C1′, moved from the first position 211 is unloaded from the unloading position 213.

FIG. 3 shows a third conventional conveyer system 300. The conveyer system 300 also includes a buffer zone 330 between a conveyor 320 and a stocker 310, the buffer zone 330 extending from the conveyor 320 and comprising a first Input/Output port 321 and second Input/Output port 322, with the stocker 310 comprises a first position 311 and a second position 312. Cassettes C4 and C5 are respectively placed in first position 311 and second position 312 and respectively output material therefrom to the first Input/Output port 321 and the second Input/Output port 322. When cassette C4 is empty, cassette C5 can provide material such that conveyor activity is uninterrupted.

Although the second and third conventional conveyer systems 200 and 300 address interruptions during cassette exchange, the buffer zones require additional space, creating logistic, physical, and cost-related problems in the manufacturing environment.

### SUMMARY OF THE INVENTION

Accordingly, an object of the invention is to provide a conveyer system that conserves working space and transport time of conveyors entering stockers.

The present invention provides a conveyer system comprising a stocker and a conveyor. The stocker has a first position and a second position. The conveyor with an Input/Output port enters the stocker, with the Input/Output port is disposed between the first position and the second position.

According to the present invention, the Input/Output port of the conveyor receives material from two cassettes in adjacent first and second positions, or delivers material to the cassettes. Because two cassettes provide or receive material in turn, conveyor activity is uninterrupted during cassette exchange, streamlining the manufacture process. Furthermore, the arrangement of the conveyer system without buffer zones has no impact on the limited working space of the clean room.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a first conventional conveyer system;

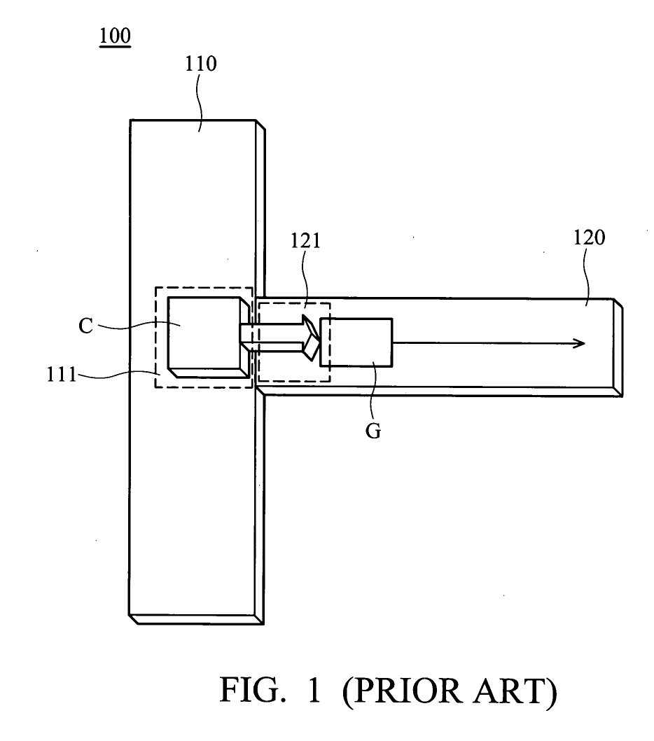

FIG. 2 shows a second conventional conveyer system;

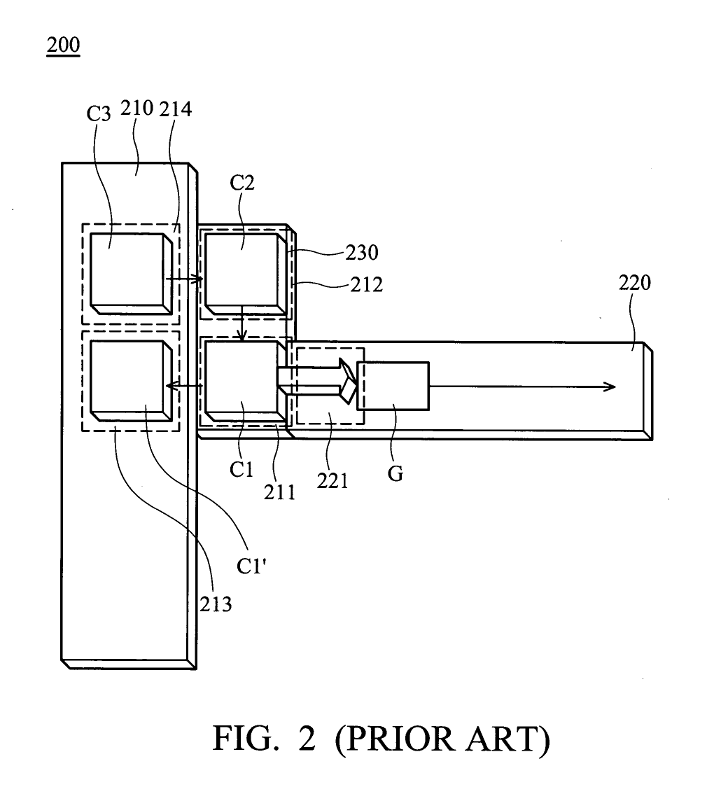

FIG. 3 shows a third conventional conveyer system;

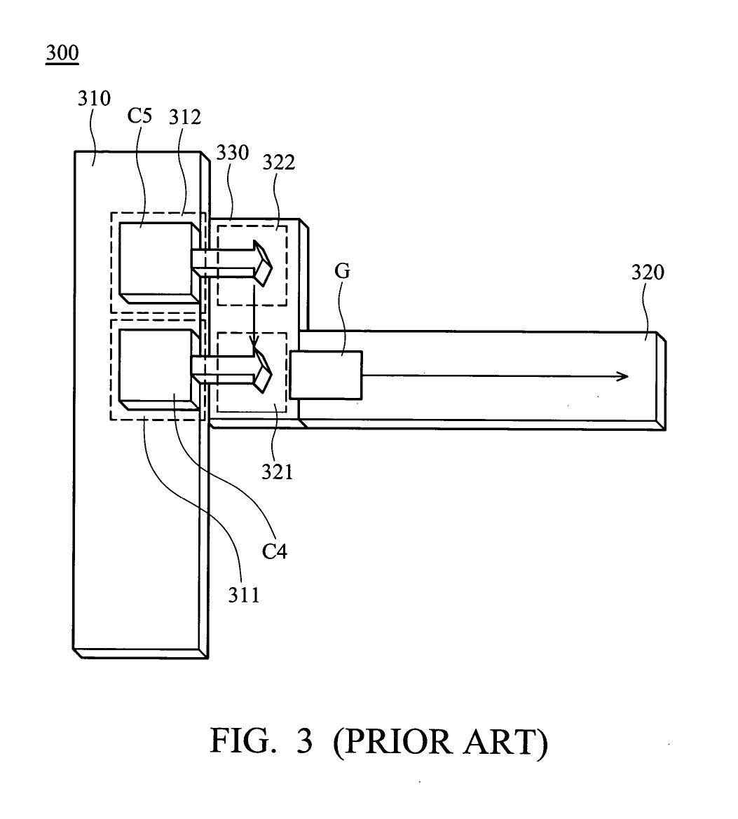

FIG. 4 shows a conveyer system of the present embodiment.

### DETAILED DESCRIPTION OF THE INVENTION

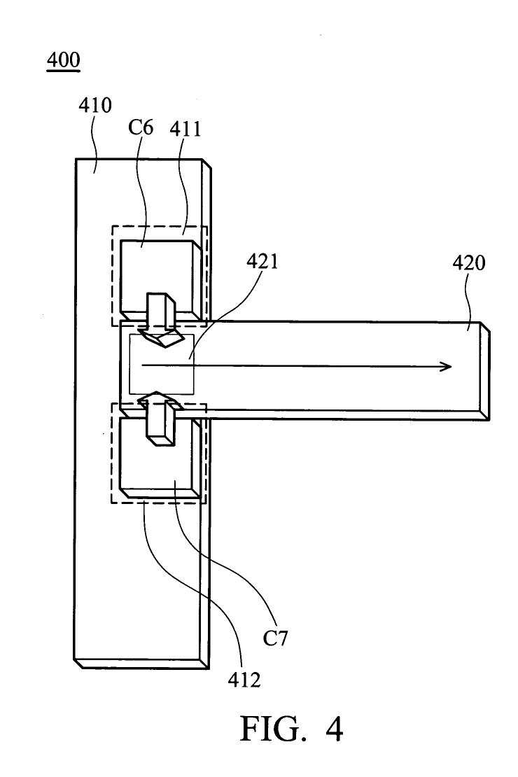

FIG. 4 shows conveyer system 400 of the present invention. The conveyer system 400 comprises a stocker 410 and a conveyor 420, the stocker 410 having a first position 411 and a second position 412, with cassettes C6 and C7 respectively in the first position 411 and the second position 412. The conveyor 420, with an Input/Output port 421 enters the stocker 410, between the first position 411 and the second position 412.

During transport from the stocker 410 to the Input/Output port 421, material is provided by cassettes in the first and second positions in turn. In the present embodiment, material is provided by the first cassette C6 in the first position 411, delivered to the Input/Output port 421, and transported by the conveyor 420. When the first cassette C6 is empty, the second cassette C7 in the second position 412 is delivered to the Input/Output port 421, and transported by the conveyor 420. As material is removed from the second cassette C7, the empty first cassette C6 is exchanged with a third cassette (not shown in FIG. 4) stocked. When the second cassette C7 is empty, it is exchanged with a fourth cassette (not shown in FIG. 4), such that material is continuously provided by the third cassette in the first position 411.

The conveyer system 400 can also move material into the stocker 410 for storage, wherein the Input/Output port delivers material to the cassettes in the first position 411 and the second position 412 in turn. During stowage, material is transported by the conveyor 420, and delivered to the first cassette C6 placed in the first position 411 through the Input/Output port 421. When the first cassette C6 is stocked, the Input/Output port 421 delivers material to the second cassette C7 in the second position 412. When the Input/Output port 421 delivers material to the second cassette C7, the full first cassette C6 in the first position 411 can be exchanged with a third cassette (not shown in FIG. 4) awaiting stocking. When the second cassette C7 is stocked, it is exchanged with a fourth cassette (not shown in FIG. 4), such that material is continuously delivered to the third cassette in the first position 411.

According to the present invention, the Input/Output port of the conveyor receives material from two cassettes in adjacent first and second positions, or delivers material to the cassettes. Because two cassettes provide or receive material in turn, conveyor activity is uninterrupted during cassette exchange, streamlining the manufacture process. Furthermore, the arrangement of the conveyer system without buffer zone has no impact on the limited working space of the clean room.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A conveyer system for material transported in cassettes, comprising:
a stocker having a first position and a second position; and
a conveyor entering the stocker and having an Input/Output port between the first position and the second position.

2. The conveyer system as claimed in claim 1, wherein the cassettes in the first and the second positions alternately deliver material to the Input/Output port.

3. The conveyer system as claimed in claim 1, wherein the Input/Output port receives material from a first cassette in the first position to transport material from the stocker, and the Input/Output port receives material from a second cassette in the second position to transport material from the stocker when the first cassette has been emptied.

4. The conveyer system as claimed in claim 1, wherein the Input/Output port delivers material to the cassettes in the first and the second position alternately.

5. The conveyer system as claimed in claim 1, wherein the conveyor transports material through the Input/Output port in a first cassette in the first position, and in a second cassette in the second position when the first cassette is full, the first cassette replaced with a third cassette.
